(19) United States
(12) Patent Application Publication
(10) Pub. No.: US 2024/0100493 A1
(43) Pub. Date: Mar. 28, 2024

(54) MIXING DEVICE

(71) Applicant: CONTEMPORARY AMPEREX TECHNOLOGY CO., LIMITED, Ningde (CN)

(72) Inventors: Jinwu WU, Ningde (CN); Fangnan XU, Ningde (CN); Ning ZHANG, Ningde (CN); Bin ZHAO, Ningde (CN); Renyu CHEN, Ningde (CN)

(21) Appl. No.: 18/531,469

(22) Filed: Dec. 6, 2023

Related U.S. Application Data
(63) Continuation of application No. PCT/CN2023/091304, filed on Apr. 27, 2023.

(30) Foreign Application Priority Data
Sep. 15, 2022 (CN) 202222448382.7

(51) Int. Cl. B01F 35/214; B01F 25/00; B01F 25/40; B01F 35/21; B01F 35/71

(52) U.S. Cl. CPC B01F 35/214; B01F 25/105; B01F 25/40; B01F 35/2131; B01F 35/7174

(57) ABSTRACT

A mixing device includes a conveying part, a discharging pipe and a detecting part. The conveying part is internally provided with a plurality of conveying channels, and the plurality of conveying channels are used for correspondingly conveying various materials. The discharging pipe is internally provided with a mixing channel and connected to the conveying part, and each of the conveying channels communicates with the mixing channel. The detecting part is used for detecting a color of the mixed material obtained after the various materials are mixed in the mixing channel.

### CROSS-REFERENCE TO RELATED APPLICATIONS

The present application is a continuation of International Application No. PCT/CN2023/091304, filed on Apr. 27, 2023, which claims priority to Chinese Patent Application No. 202222448382.7 filed on Sep. 15, 2022 and entitled “MIXING DEVICE”, the entire contents of both of which are incorporated herein by reference.

### TECHNICAL FIELD

The present application relates to the technical field of material mixing equipment, in particular to a mixing device.

### BACKGROUND

A mixing device can mix various materials to obtain a mixed material. For example, components of glue may be mixed by means of the mixing device to obtain the glue.

When mixing the various materials, it is needed to keep ratios of various materials within a certain range. Taking the glue as an example, in order to improve bonding quality, it is needed to ensure that the ratio of each component in the glue is within a set range. An existing mixing device measures a flow rate of the components through a flowmeter and then calculates the ratio of each component in the glue to determine whether the ratio of the components meets the requirements. This measurement mode has low efficiency and reduces production efficiency.

### SUMMARY

The objective of the present application is to provide a mixing device, which can improve efficiency of detecting whether a ratio of components of a mixed material meets the requirements.

An embodiment of the present application provides a mixing device, including a

conveying part, a discharging pipe and a detecting part. The conveying part is internally provided with a plurality of conveying channels, and the plurality of conveying channels are used for correspondingly conveying various materials. The discharging pipe is internally provided with a mixing channel and connected to the conveying part, and each of the conveying channels communicates with the mixing channel. The detecting part is used for detecting a color of the mixed material obtained after the various materials are mixed in the mixing channel.

In the above solution, the mixing device is internally provided with the detecting part. The color of the mixed material obtained after the various materials are mixed in the mixing channel can be detected through the detecting part, and according to the color of the mixed material, whether a ratio of each component of the mixed material meets the requirements may be determined, and it is not necessary to determine a proportion of the components in the mixed material by separately detecting a flow rate of each component in the mixed material, which improves the efficiency of detecting whether the ratio of the components of the mixed material meets the requirements.

In some embodiments, the detecting part is arranged outside the discharging pipe.

The detecting part is arranged outside the discharging pipe, so that materials in the mixing channel will not make direct contact with the detecting part, which reduces a possibility of the detecting part being corroded by the materials or being damaged due to abrasion, and prolongs a service life of the detecting part.

In some embodiments, the discharging pipe has a transparent area made of a transparent material, the detecting part is arranged outside the discharging pipe, and the detecting part is configured to detect the color of the various material after mixing in the mixing channel through the transparent area.

In the above solution, the detecting part detects the materials through the transparent area, and the detecting part may be arranged outside the discharging pipe, so that the detecting part may also measure the ratio of the components in the mixed material without making direct contact with a material medium.

In some embodiments, the entire discharging pipe is a transparent material.

In the above solution, the discharging pipe is transparent as a whole, so that the detecting part may be arranged at any position outside the discharging pipe, which is convenient for adjusting an installation position of the detecting part and improves a detecting effect.

In some embodiments, the material of the discharging pipe includes at least one of glass and plastic.

In the above solution, the glass and the plastic have better light transmission, which improves the detecting effect of the detecting part.

In some embodiments, the mixing device further includes a light source, and the light source is used for providing illuminating light to the transparent area.

In the above solution, the light source illuminates the transparent area, so that the detecting part can clearly detect the color of the materials in the mixing channel, which improves detecting accuracy.

In some embodiments, the light source is arranged on the detecting part.

In the above solution, the light source is arranged on the detecting part, so that the light source can be illuminated within a detecting range of the detecting part, thereby improving an illuminating effect of the light source.

In some embodiments, the conveying part has an output end, the discharging pipe includes a sleeving section and a mixing section, the mixing section is connected to the sleeving section, the sleeving section sleeves the output end, and the mixing section is used for mixing the various materials.

In the above solution, the sleeving section sleeves the output end, which reduces a possibility of leakage when the materials enter the mixing channel from the conveying channel.

In some embodiments, the detecting part includes a color recognition camera.

In the above solution, the color of the mixed material can be quickly and accurately recognized by the color recognition camera, which improves the detecting efficiency and the detecting effect.

In some embodiments, the mixing device further includes a bracket, and the bracket connecting the conveying part with the detecting part, so as to keep the detecting part outside the discharging pipe.

In the above solution, the detecting part is fixed to the conveying part through the bracket, and then a position of the detecting part relative to the mixing channel is fixed, so that the detecting part may be kept outside the discharging pipe.

In some embodiments, the conveying part has the output end and a connecting end, the output end and the connecting end are arranged oppositely in a first direction, the discharging pipe is connected to the output end, and the bracket is connected to the connecting end.

In the above solution, the bracket is connected to the connecting end, so as to avoid blocking the part connected to the output end.

In some embodiments, the bracket includes a first section, a second section and a third section connected in sequence, the first section is connected to the connecting end, the second section extends in the first direction, the first section and the third section are arranged oppositely in the first direction and are respectively connected to both ends of the second section, and the detecting part is connected to one end of the third section far away from the second section.

In the above solution, the first section is connected to the connecting end, so that the second section and the third section may be arranged to be spaced from the conveying part, so as to prevent the second section and the third section from blocking the part connected to the output end.

In some embodiments, a movable part is arranged inside the conveying part, the movable part includes a plurality of pistons, the pistons correspond to the conveying channels one by one, the pistons are movably arranged in the conveying channel, and the pistons are configured to drive the materials in the conveying channels to enter the mixing channel.

In the above solution, after the materials are input into the conveying channels, the materials are pushed by the pistons so that the material can enter the mixing channel.

In some embodiments, the movable part further includes a connecting element, and the connecting element is used for connecting the plurality of pistons.

In the above solution, the pistons are connected through the connecting element, so that the plurality of pistons may be driven by one driving part, which saves cost.

In some embodiments, in a circumferential direction of the conveying part, an outer peripheral surface of the conveying part is provided with a plurality of feeding ports, and each of the feeding ports communicates with one of the conveying channels.

In the above solution, the feeding ports are formed on the peripheral surface of the conveying part, so as to facilitate communication between the plurality of material conveying channels and the corresponding feeding ports.

In some embodiments, the conveying part is internally provided with two conveying channels.

In the above solution, the two conveying channels can convey the two materials to the mixing channel for mixing, and the color of the mixed material is detected by the detecting part to determine whether the ratio of the two materials is correct.

The above description is only a summary of the technical solutions of the present application. In order to be able to understand the technical means of the present application more clearly, and the technical means can be implemented according to the content of the specification, furthermore, in order to make the above and other objectives, features and advantages of the present application more obvious and understandable, specific implementations of the present application are exemplified below.

### BRIEF DESCRIPTION OF THE DRAWINGS

Various other advantages and benefits will become apparent to those of ordinarily skilled in the art upon reading the following detailed description of some implementations. The drawings are for the purpose of illustrating some implementations only and are not to be considered as a limitation to the present application. Furthermore, the same parts are denoted by the same reference numerals throughout the drawings. In the drawings:

FIG. 1 is a schematic structural diagram of a mixing device provided by some embodiments of the present application.

FIG. 2 is a schematic diagram of an internal structure of a mixing device provided by some embodiments of the present application.

FIG. 3 is an enlarged view of a position A of FIG. 2.

FIG. 4 is a schematic structural stereoscopic diagram of a mixing device provided by some embodiments of the present application.

FIG. 5 is a schematic structural diagram of a conveying part provided by some embodiments of the present application.

Reference numerals in Detailed Description are as follows:
10—Conveying part; 101—feeding port; 102—Movable part; 1021—Piston; 1022—connecting element; 103—Conveying channel; 104—Output end; 105—Connecting end; 20—Discharging pipe; 201—Sleeving section; 202—Mixing section; 203—Mixing channel; 30—Detecting part; 40—Bracket; 401—Third section; 402—Second section; 403—First section; and 100—Mixing device.

### DETAILED DESCRIPTION

Embodiments of the technical solution of the present application will be described in detail below in conjunction with the drawings. The following embodiments are only used to more clearly illustrate the technical solution of the present application, and therefore are only used as examples and cannot be used to limit the scope of protection of the present application.

Unless otherwise defined, all technical and scientific terms used herein have the same meaning as commonly understood by those skilled in the art belonging to the technical field of the present application; the terms used herein are intended only for the purpose of describing specific embodiments and are not intended to limit the present application; and the terms “including” and “having” and any variations thereof in the specification and the claims of the present application and in the description of drawings above are intended to cover non-exclusive inclusion.

In the description of the embodiments of the present application, the technical terms “first”, “second”, and the like are used only to distinguish between different objects, and cannot be understood as indicating or implying a relative importance or implicitly specifying the number, particular order, or primary and secondary relation of the technical features indicated. In the description of the embodiment of the present application, unless otherwise limited expressly and specifically, the meaning of “the plurality of” is more than two.

Reference herein to “an embodiment” means that a particular feature, structure, or characteristic described in combination with the embodiment may be contained in at least one embodiment of the present application. The appearance of this phrase in various positions in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

In the description of the embodiment of the present application, the term “and/or” is only an association relationship to describe an association object, and represents that there may be three kinds of relationships, for example, A and/or B, may represent: A exists alone, A and B exist at the same time, and B exists alone. In addition, a character “/” herein generally represents that the previous and next association objects are in an “or” relationship. In this disclosure, the phrases “at least one of A, B, and C” and “at least one of A, B, or C” both mean only A, only B, only C, or any combination of A, B, and C.

In the description of the embodiment of the present application, the term “a plurality of” refers to more than two, and similarly, “a plurality of groups” refers to more than two groups, and “a plurality of sheets” refers to more than two sheets.

In the description of the embodiment of the present application, an orientation or position relationship indicated by the technical terms “center”, “longitudinal”, “transversal”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, etc. are based on the orientation or position relationship shown in the drawings and are intended to facilitate the description of the embodiment of the present application and simplify the description only, rather than indicating or implying that the device or element referred to must have a particular orientation or be constructed and operated in a particular orientation, and therefore cannot be understood as limitation on the embodiment of the present application.

In the description of the embodiment of the present application, unless otherwise expressly stated and limited, the technical terms “install”, “connect”, “link” and “fix” should be understood in a broad sense, for example, they may be a fixed connection, or a detachable connection, or integration; may also be a mechanical connection, or an electrical connection; and may be a direct connection, or an indirect connection through an intermediate medium, or internal communication of two elements or interaction between the two elements. Those ordinarily skilled in the art may understand the specific meaning of the above terms in the embodiment of the present application according to the specific situation.

In the embodiment of the present application, the same reference numerals denote the same part, and for the sake of brevity, detailed descriptions of the same part are omitted in different embodiments. It should be understood that a thickness, length, width and other dimensions of the various parts in the embodiment of the present application shown in the drawings, as well as an overall thickness, length and width of an integrated device, are for illustrative purposes only, and should not constitute any limitation to the present application.

A mixing device can mix various materials to obtain a mixed material. Taking a battery production process as an example, in a battery assembly process, glue is used in many places for bonding. For example, a battery cell is fixed to a box body by the glue. When the box body includes a bottom guard, the bottom guard is initially fixed to the box body by the glue; and a temperature management part in the box body (such as a water cooling plate) is also connected with the box body by the glue. The glue usually includes multiple components, so it is needed to use a mixing device to mix the multiple components.

In order to ensure that the glue has good bonding quality, each component needs to be mixed in a certain ratio. Therefore, it is needed to detect a proportion of each component of the glue in the glue. Most of existing mixing devices measure a flow rate of the components passing into the mixing device through a flowmeter, and then calculate a ratio of each component through the flow rate of each component. This detecting mode has low efficiency and complicated process, and reduces production efficiency.

Based on the problem above, an embodiment of the present application provides a mixing device, including a conveying part, a discharging pipe and a detecting part. The conveying part is internally provided with a plurality of conveying channels, and the plurality of conveying channels are used for correspondingly conveying various materials. The discharging pipe is internally provided with a mixing channel and connected to the conveying part, and each of the conveying channels communicates with the mixing channel. The detecting part is used for detecting a color of the mixed material obtained after the various materials are mixed in the mixing channel.

The detecting part in the mixing device determines the ratio of each component in the mixed material by detecting the color after mixing of the materials. It is not necessary to determine a proportion of the components in the mixed material by separately detecting a flow rate of each component in the mixed material, which simplifies a detecting process, and improves efficiency of detecting whether the ratio of the components of the mixed material meets the requirements.

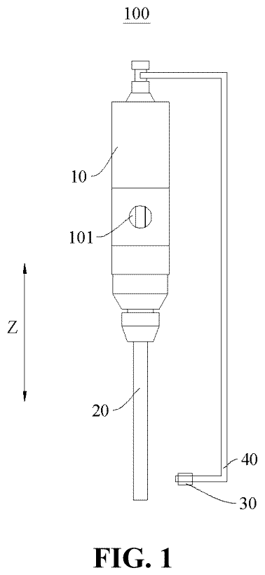

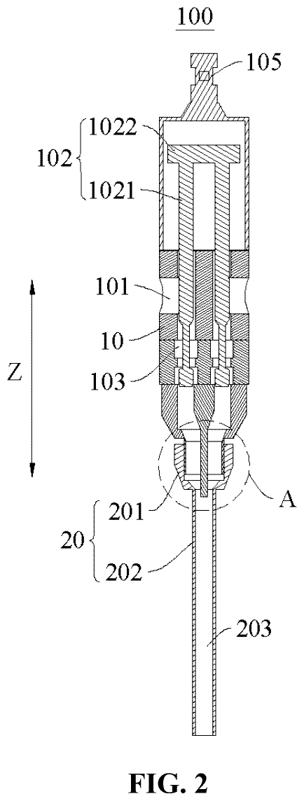

According to some embodiments of the present application, please refer to FIG. 1 and FIG. 2, FIG. 1 is a schematic structural diagram of mixing device 100 provided by some embodiments of the present application, and FIG. 2 is a schematic diagram of an internal structure of mixing device 100 provided by some embodiments of the present application. An embodiment of the present application provides mixing device 100, including conveying part 10, discharging pipe 20 and detecting part 30. Conveying part 10 is internally provided with a plurality of conveying channels 103, and the plurality of conveying channels 103 are used for correspondingly conveying various materials. Discharging pipe 20 is internally provided with a mixing channel 203 and connected to the conveying part 10, and each of the conveying channels 103 communicates with the mixing channel 203. Detecting part 30 is used for detecting the color of the mixed material obtained after the various materials are mixed in the mixing channel 203.

The mixed material in the embodiment of the present application may be glue, and mixing device 100 may be used for mixing various components of the glue. Each component may be solid (the solid components are mixed and then subjected to other processing steps to form liquid glue), may also be all liquid, may also be a mixture of solid and liquid, and the color of each component may be different.

Conveying part 10 is used for conveying the materials, and conveying part 10 may include a part that drives the materials to move along conveying channels 103. For example, conveying part 10 may also include conveying pumps that correspond to conveying channels 103 one by one. The materials are pumped into conveying channels 103 through the conveying pumps continuously, so that the materials may move along conveying channels 103. For another example, conveying part 10 may further include a helical blade, the helical blade is arranged in conveying channels 103 and is rotatably connected with conveying part 10. By driving the helical blade to rotate, a purpose of pushing the materials to move is achieved.

Discharging pipe 20 may be integrally formed with conveying part 10, or may be a separate part connected to conveying part 10. Mixing channel 203 formed by discharging pipe 20 may be internally provided with a stirring part, and the stirring part may be a stirring blade rotatably connected with discharging pipe 20. The materials in mixing channel 203 are stirred through the stirring blade, which improves a mixing uniformity.

The color of the mixed material formed by mixing the plurality of materials of different colors through mixing channel 203 will change. By detecting the color of the mixed material through detecting part 30, whether the ratio of each component of the mixed material is within a set range may be determined. In a using process, a control group may be blended in advance, the material components in the control group are within the set range, a color of the control group is recorded by taking pictures or obtaining RGB color parameters of the material color of the control group, and then the color detected by detecting part 30 is compared with the color of the control group. If the color has a deviation, the ratio of the material components in mixing channel 203 is wrong at this time. If the color is consistent or the deviation is within an allowable range of error, the ratio of the material components in mixing channel 203 is correct.

In the embodiment of the present application, detecting part 30 may be arranged inside discharging pipe 20 or outside discharging pipe 20.

The color of the mixed material obtained after the various materials are mixed in mixing channel 203 can be detected through detecting part 30, and according to the color of the mixed material, whether a ratio of each component of the mixed material meets the requirements may be determined, and it is not necessary to determine a proportion of the components in the mixed material by separately detecting the flow rate of each component in the mixed material, which improves the efficiency of detecting whether the ratio of the components of the mixed material meets the requirements.

In addition, the color of the mixed material may be detected by one detecting part 30, and mixing device 100 does not need to arrange a plurality of flowmeters corresponding to the quantity of the components, so that a structure of mixing device 100 is more streamlined, and a manufacturing and maintenance cost of mixing device 100 is reduced.

According to some embodiments of the present application, detecting part 30 is arranged outside discharging pipe 20.

Detecting part 30 may be arranged towards an outer peripheral surface of discharging pipe 20, an observation window or a hole is formed in discharging pipe 20, and detecting part 30 detects the mixed material inside discharging pipe 20 through a peripheral wall of the discharging pipe 20. Detecting part 30 may further be arranged towards an outlet of discharging pipe 20, and detecting part 30 detects the mixed material inside discharging pipe 20 from an outlet of discharging pipe 20.

Detecting part 30 is arranged outside discharging pipe 20, so that the materials in mixing channel 203 will not make direct contact with detecting part 30, which reduces a possibility of detecting part 30 being corroded by the materials or being damaged due to abrasion, and prolongs a service life of detecting part 30.

According to some embodiments of the present application, referring to FIG. 1, discharging pipe 20 has a transparent area made of a transparent material, detecting part 30 is arranged outside discharging pipe 20, and detecting part 30 is configured to detect the color of the various materials after mixing in mixing channel 203 through the transparent area.

The transparent area may be a section of the discharging pipe 20 formed by a transparent material. It may also be formed by closing an observation hole with the transparent material after forming the observation hole in discharging pipe 20, and the observation hole may be circular, rectangular or other polygonal.

Detecting part 30 can detect the materials through the transparent area, and detecting part 30 may be arranged outside discharging pipe 20, so that detecting part 30 may also measure the ratio of the components in the mixed material without making direct contact with a material medium. On the one hand, it avoids abrasion of detecting part 30 when making contact with the materials, and on the other hand, it avoids corrosive damage to detecting part 30 and reduces the service life.

In the present embodiment, the transparent material includes at least one of glass and plastic. The glass may be ultra-white glass. The plastic may be polymethyl methacrylate, polycarbonate or polyethylene terephthalate.

According to other embodiments of the present application, discharging pipe 20 may also not have the transparent area. For example, the observation hole is formed in the peripheral wall of an outlet pipe. In a detecting stage, detecting part 30 detects the color of the mixed material through the observation hole. After detecting is completed, the observation hole is closed to prevent the leakage of the mixed material. Detecting part 30 may further be detachably connected to conveying part 10, and detecting part 30 is directly facing an outlet of discharging pipe 20. After detecting is completed, detecting part 30 is disassembled.

According to some embodiments of the present application, entire discharging pipe 20 is a transparent material.

If discharging pipe 20 is partially transparent, detecting part 30 can only be fixed at one position relative to discharging pipe 20, which is not convenient for installation and arrangement of detecting part 30.

Discharging pipe 20 is transparent as a whole, so that detecting part 30 may be arranged at any position outside discharging pipe 20, which is convenient for adjusting an installation position of detecting part 30 and improves a detecting effect.

According to some embodiments of the present application, the material of discharging pipe 20 includes at least one of glass and plastic.

The glass may be ultra-clear glass. The plastic may be polymethyl methacrylate, polycarbonate or polyethylene terephthalate.

Discharging pipe 20 may be made only of the glass or the plastic, and may also be partially made of the glass and partially made of the plastic.

Light transmittance of the glass and plastic is good, so that detecting part 30 can accurately detect the color of the materials through discharging pipe 20 as well, and the detecting effect of detecting part 30 is improved.

According to some embodiments of the present application, mixing device 100 further includes a light source, and the light source is used for providing illuminating light to the transparent area.

A shadow of discharging pipe 20 is eliminated by the light source, and the detecting accuracy is improved.

The light source may be a ring-shaped light source, so that the light is evenly diffused. For example, the light source may include a plurality of lighting lamps, and mixing device 100 may further include a ring-shaped installation seat, and the plurality of lighting lamps are arranged on the installation seat in a circular array to form the ring-shaped light source. For another example, the light source may further be an annular light-emitting light strip.

The light source illuminates the transparent area, so that detecting part 30 can clearly detect the color of the materials in mixing channel 203, which improves the detecting effect.

According to some embodiments of the present application, the light source is arranged on detecting part 30.

The light source may be a part of detecting part 30, or an external part connected to detecting part 30.

The light source may be arranged at a detecting end of detecting part 30 which plays a detecting role. For example, when detecting part 30 includes a color recognition camera, the light source may be arranged at a lens of detecting part 30.

The light source may be detachably connected with detecting part 30 to facilitate replacement of the light source.

The light source is arranged on detecting part 30, so that the light source can be illuminated in a detecting range of detecting part 30, and an illuminating effect of the light source is improved. For example, when detecting part 30 includes the color recognition camera, the light source is arranged at the lens of the color recognition camera and is illuminated to the transparent area, thereby reducing a possibility of the shadow at a shooting position of the color recognition camera. Furthermore, when the position of detecting part 30 is adjusted, the light source moves together, and there is no need to adjust a relative position of the two, which improves working efficiency.

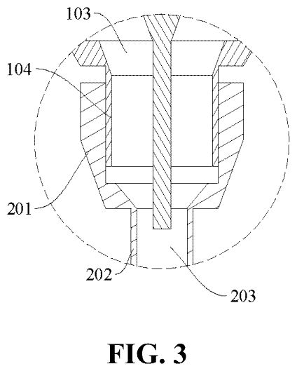

According to some embodiments of the present application, please refer to FIG. 3, and FIG. 3 is an enlarged view of a position A of FIG. 2. Conveying part 10 has output end 104, discharging pipe 20 includes sleeving section 201 and mixing section 202, mixing section 202 is connected to sleeving section 201, sleeving section 201 sleeves output end 104, and mixing section 202 is used for mixing the various materials.

Conveying channels 103 in conveying channels 103 may converge at output end 104, and the materials in each conveying channel 103 are output to mixing section 202 through output end 104.

Sleeving section 201 plays a connection role, and connects mixing section 202 to conveying part 10, so that the materials can enter mixing section 202, and mixing section 202 has a mixing role on the materials.

Sleeving section 201 and mixing section 202 may be integrally formed, or may be mutually-independent parts.

An inner diameter of sleeving section 201 may be greater than an outer diameter of output end 104, so that sleeving section 201 sleeves output end 104. Sleeving section 201 and output end 104 may be welded, and an inner wall of sleeving section 201 and an outer wall of output end 104 may be respectively provided with threads, so that when sleeving section 201 sleeves output end 104, the two may be in threaded connection.

When sleeving section 201 is connected to output end 104 in the sleeving mode, the inner wall of sleeving section 201 is sleeved on the outer peripheral surface of output end 104, so that a gap between discharging pipe 20 and output end 104 is sealed. After being discharged from output end 104, the materials may directly enter mixing section 202, which reduces the possibility of the leakage when the materials enter mixing channel 203 from conveying channels 103.

According to some embodiments of the present application, please refer to FIG. 1, detecting part 30 includes the color recognition camera.

In the embodiment where discharging pipe 20 has the transparent area, the color recognition camera may detect the color of the materials inside discharging pipe 20 through the transparent area of discharging pipe 20, so that the color recognition camera may be arranged outside discharging pipe 20, so as to avoid direct contact of the color recognition camera with a corrosive material.

The working principle of the color recognition camera being able to recognize the color of the materials is content disclosed in the related art, and will not be repeated here.

The color of the mixed material can be quickly and accurately recognized by the color recognition camera, which improves the detecting efficiency and the detecting effect.

In other embodiments, detecting part 30 may be a color recognition sensor, the color recognition sensor is connected with a processor, and data measured by the color recognition sensor is processed by the processor and then fed back to a user, or the processor compares the data with the RGB color parameters of the control group, and feeds back a result of whether the ratio of the components of the materials is correct to the user.

According to some embodiments of the present application, please refer to FIG. 1, mixing device 100 further includes bracket 40, bracket 40 connects conveying part 10 and detecting part 30 to keep detecting part 30 outside discharging pipe 20.

Bracket 40 plays a role of connecting and supporting, so that detecting part 30 may be connected to conveying part 10 and kept outside discharging pipe 20.

Bracket 40 may be of a rod-shaped structure, and two ends of bracket 40 may be detachably connected to conveying part 10 and detecting part 30 respectively. Further, bracket 40 may further be of a hollow structure, which keeps a supporting effect of bracket 40 and reduces a weight of bracket 40 at the same time.

Detecting part 30 is fixed to conveying part 10 through bracket 40, and the position of detecting part 30 relative to mixing channel 203 is further fixed to improve the detecting accuracy of detecting part 30.

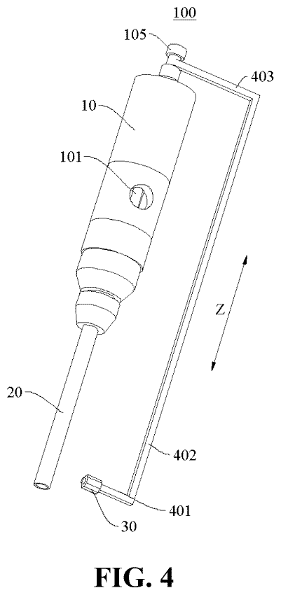

According to some embodiments of the present application, please refer to FIG. 4, and FIG. 4 is a schematic structural stereoscopic diagram of mixing device 100 provided by some embodiments of the present application. Conveying part 10 has output end 104 and connecting end 105. In a first direction, output end 104 and connecting end 105 are arranged oppositely, discharging pipe 20 is connected to output end 104, and bracket 40 is connected to connecting end 105.

The first direction may be a direction pointed by a Z axis in FIG. 4, and at the same time, an axis of mixing channel 203 may be parallel to the Z axis.

Connecting end 105 plays a connecting role, so that bracket 40 may be connected to connecting end 105. Connecting end 105 may be provided with an insertion hole, and bracket 40 may be inserted into the insertion hole, so that bracket 40 is connected with connecting end 105.

Output end 104 and connecting end 105 are arranged oppositely. On the one hand, when bracket 40 is connected to conveying part 10, it may be needed to form the insertion hole or a threaded hole for bolt connection in conveying part 10. If the insertion hole or the threaded hole is formed in output end 104, when the insertion hole or threaded hole is machined, hidden damage may be formed on output end 104, which increases a risk of leakage at output end 104. Therefore, bracket 40 is connected to connecting end 105 and connecting end 105 is made be as far away from output end 104 as possible, which may increase reliability of output end 104. On the other hand, when the materials are introduced into conveying channel 103, it is needed to make an external pipeline communicate with conveying channel 103. If bracket 40 is directly connected to output end 104, bracket 40 may block the external pipeline, making the external pipeline be unable to be connected to conveying channel 103, so connecting bracket 40 to connecting end 105 increases an operable space of output end 104 and avoids blocking the part connected to output end 104.

According to some embodiments of the present application, please refer to FIG. 4, bracket 40 includes first section 403, second section 402 and third section 401 connected in sequence, first section 403 is connected to connecting end 105, second section 402 extends in the first direction, first section 403 and third section 401 are arranged oppositely in the first direction and are respectively connected to both ends of second section 402, and detecting part 30 is connected to one end of third section 401 far away from second section 402.

First section 403, second section 402, and third section 401 may form a U-shaped structure with an opening facing conveying part 10, so that second section 402 may be as far away from conveying part 10 as possible. Third section 401 may be arranged to be spaced from conveying part 10, so as to prevent second section 402 and third section 401 from blocking the part connected to output end 104.

First section 403, second section 402 and third section 401 may be integrally formed. For example, bracket 40 may be bent to form first section 403, second section 402 and third section 401. First section 403, second section 402 and third section 401 may also be independent of each other, and mutually form bracket 40 by welding.

Third section 401 may extend to a direction gradually close to discharging pipe 20 in a direction perpendicular to the axis of discharging pipe 20, and detecting part 30 is connected to one end of third section 401 far away from second section 402, so that detecting part 30 may be close to discharging pipe 20 as much as possible to improve the detecting effect of detecting part 30.

According to some embodiments of the present application, please refer to FIG. 2, movable part 102 is arranged inside conveying part 10, movable part 102 includes a plurality of pistons 1021, pistons 1021 correspond to conveying channels 103 one by one, pistons 1021 are movably arranged in conveying channel 103, and pistons 1021 are configured to drive the materials in conveying channels 103 to enter mixing channel 203.

Pistons 1021 may be in sliding and sealing fit with the inner walls of conveying channels 103, and when pistons 1021 move at the outlet ends of conveying channels 103, the materials in conveying channels 103 can be pushed to move to outlets of conveying channels 103.

The plurality of pistons 1021 may be connected together to move synchronously, or may move independently of each other.

Pistons 1021 may reciprocate along the axis of conveying channels 103. When pistons 1021 move to a limit position away from the outlets of conveying channels 103, the materials may be input into conveying channels 103, so that when pistons 1021 move to the outlets of conveying channels 103 again, the materials can be pushed out.

Furthermore, pistons 1021 may make the materials under pressure, and when the various materials are conveyed to mixing channel 203, the mixing uniformity is improved.

According to some embodiments of the present application, please refer to FIG. 2, movable part 102 further includes connecting element 1022, and connecting element 1022 is used for connecting the plurality of pistons 1021.

Pistons 1021 and connecting element 1022 may be detachably connected, or integrally formed.

Pistons 1021 may include a sealing section and a connecting section, the sealing section is in sliding and sealing fit with the inner walls of conveying channels 103, and the connecting section is connected to connecting element 1022.

Movable part 102 may further include a driving part, which is used for driving

connecting element 1022 to move, and then driving pistons 1021 to move. The driving part may be an air cylinder or a hydraulic cylinder, a cylinder body of the air cylinder or hydraulic cylinder is connected with conveying part 10, and a telescopic end of the air cylinder or hydraulic cylinder is connected to connecting element 1022.

Pistons 1021 are connected through connecting element 1022, so that the plurality of pistons 1021 may be driven by one driving part, which saves cost.

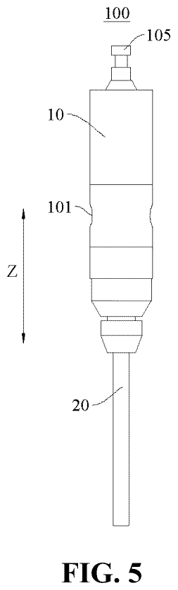

According to some embodiments of the present application, please refer to FIG. 4 and FIG. 5. FIG. 5 is a schematic structural diagram of conveying part 10 provided by some embodiments of the present application. In a circumferential direction of conveying part 10, an outer peripheral surface of conveying part 10 is provided with a plurality of feeding ports 101, and each of feeding ports 101 communicates with one of the conveying channels 103.

When pistons 1021 are in a state be far away from the outlet ends of conveying channels 103, feeding ports 101 may be formed somewhere between pistons 1021 and the outlets of conveying channels 103, so that the materials input from feeding ports 101 into the conveying channels 103 may be pushed out through pistons 1021.

The plurality of feeding ports 101 may be distributed at circumferential intervals, so as to avoid interference when the external pipeline communicates with conveying channels 103.

According to some embodiments of the present application, please refer to FIGS. 2 and FIG. 5, conveying part 10 internally provided with two conveying channels 103.

Conveying part 10 may be a block-shaped piece, and conveying channels 103 may be formed by forming the holes on conveying part 10.

Two conveying channels 103 can convey the two materials to mixing channel 203 for mixing, and the color of the mixed material is detected by detecting part 30 to determine whether the ratio of the two materials is correct.

According to some embodiments of the present application, please refer to FIG. 1 to FIG. 5, an embodiment of the present application provides mixing device 100 used for mixing two different colors of liquid glue, and mixing device 100 includes conveying part 10, discharging pipe 20 and detecting part 30. Conveying part 10 is internally provided with two conveying channels 103, and two conveying channels 103 are used for correspondingly conveying two kinds of glue. Discharging pipe 20 is internally provided with mixing channel 203, discharging pipe 20 is connected to conveying part 10, and each of conveying channels 103 communicates with mixing channel 203. Discharging pipe 20 is made of a transparent material, and detecting part 30 includes a color recognition camera. The color recognition camera detects a color of the glue after mixing in mixing channel 203 through a peripheral wall of discharging pipe 20.

Finally, it should be noted that all the above embodiments are only used to illustrate the technical solutions of the present application but not used to limit it. Although the present application has been illustrated in detail with reference to the aforementioned embodiments, those ordinarily skilled in the art should understand that they can still modify the technical solutions recorded in all the aforementioned embodiments, or equivalently replace part or all of the technical features thereinto. However, these modifications or replacements do not make the nature of the corresponding technical solution separate from the scope of the technical solution of all the embodiments of the present application, and should be covered within the scope of the claims and specification of the present application. In particular, all the technical features mentioned in the various examples may be combined in any manner as long as there is no structural conflict. The present application is not limited to the specific embodiments disclosed herein, but rather includes all technical solutions falling within the scope of the claims.

What is claimed is:

1. A mixing device, comprising:
a conveying part, internally provided with a plurality of conveying channels, the plurality of conveying channels being configured to correspondingly convey various materials;
a discharging pipe, internally provided with a mixing channel and connected to the conveying part, each of the conveying channels communicating with the mixing channel; and
a detecting part, configured to detect a color of the mixed material obtained after the various materials are mixed in the mixing channel.

2. The mixing device according to claim 1 wherein the discharging pipe is a transparent material.

3. The mixing device according to claim 2, wherein the material of the discharging pipe comprises at least one of glass and plastic.

4. The mixing device according to claim 1, wherein the detecting part is arranged outside the discharging pipe.

5. The mixing device according to claim 4, wherein the discharging pipe has a transparent area made of a transparent material, and the detecting part is configured to detect the color of the various materials after mixing in the mixing channel through the transparent area.

6. The mixing device according to claim 5, further comprising:
a light source, configured to provide illumination light to the transparent area.

7. The mixing device according to claim 6, wherein the light source is arranged on the detecting part.

8. The mixing device according to claim 1, wherein the conveying part has an output end, the discharging pipe comprises a sleeving section and a mixing section, the mixing section is connected to the sleeving section, the sleeving section sleeves the output end, and the mixing section is used for mixing the various materials.

9. The mixing device according to claim 1, wherein the detecting part comprises a color recognition camera.

10. The mixing device according to claim 1, further comprising:
a bracket, connecting the conveying part with the detecting part, so as to keep the detecting part outside the discharging pipe.

11. The mixing device according to claim 10, wherein the conveying part has an output end and a connecting end, the output end and the connecting end are arranged oppositely in a first direction, the discharging pipe is connected to the output end, and the bracket is connected to the connecting end.

12. The mixing device according to claim 11, wherein the bracket comprises a first section, a second section and a third section connected in sequence, the first section is connected to the connecting end, the second section extends in the first direction, the first section and the third section are arranged oppositely in the first direction and are respectively connected to both ends of the second section, and the detecting part is connected to one end of the third section far away from the second section.

13. The mixing device according to claim 1, wherein a movable part is arranged inside the conveying part, the movable part comprises a plurality of pistons, the pistons correspond to the conveying channels one by one, the pistons are movably arranged in the conveying channel, and the pistons are configured to drive the materials in the conveying channels to enter the mixing channel.

14. The mixing device according to claim 13, wherein the movable part further comprises a connecting element, and the connecting element is used for connecting the plurality of pistons.

15. The mixing device according to claim 1, wherein in a circumferential direction of the conveying part, an outer peripheral surface of the conveying part is provided with a plurality of feeding ports, and each of the feeding ports communicates with one of the conveying channels.

16. The mixing device according to claim 1, wherein the conveying part is internally provided with two conveying channels.
